(19) United States
(12) Patent Application Publication
(10) Pub. No.: US 2006/0245680 A1
(43) Pub. Date: Nov. 2, 2006

(54) Polarization mode dispersion compensator and method thereof

(76) Inventors: Jens C. Rasmussen, Kawasaki (JP); Akihiko Isomura, Kawasaki (JP)

Correspondence Address: STAAS & HALSEY LLP, SUITE 700, 1201 NEW YORK AVENUE, N.W., WASHINGTON, DC, 20005, US

(21) Appl. No.: 10/595,031

(22) PCT Filed: Jul. 10, 2003
(86) PCT No.: PCT/JP03/08767

§ 371 Date: Dec. 30, 2005

(51) Int. Cl. G02B 6/00

(52) U.S. Cl. 385/11

(57) ABSTRACT

A polarization transformer in a polarization mode dispersion compensator is adjusted over its changing device characteristics with environmental changes and time by using a feedback signal indicating a state of polarization and a distortion of an output optical signal of compensating optics.

### TECHNICAL FIELD

The present invention relates to methods for controlling the state of polarization of light. In particular, the present invention relates to control methods which provide endless transformation of any varying polarization to a static polarization, or vice versa, control methods for the general transformation of any varying to any varying polarization, and polarization mode dispersion compensators which implement these control methods.

### BACKGROUND ART

The higher the bit rate of an optical transmission system, the more a specific amount of polarization mode dispersion of an optical fiber distorts the transmitted signal.

Due to polarization mode dispersion, the two modes in a so called single-mode fiber propagate with different velocities. An initial pulse splits its energy into the two modes. The two modes experience a differential delay during propagation. This leads to pulse spreading at the end of the fiber. The more the differential delay between the two modes is in the order of the bit duration, the more neighboring pulses will overlap, which leads at least to an increasing bit-error rate or even makes it impossible to differentiate the pulses. Polarization mode dispersion is due to internal birefringence (e.g. fiber core geometry irregularities) or externally induced birefringence (e.g. bending, squeezing, etc.). Because in a long single-mode fiber, polarization mode coupling occurs at randomly varying locations with randomly fluctuating strength due to e.g. environmental changes like temperature, polarization mode dispersion itself varies over time. It is well known, that the instantaneous differential group delay between the principal states of polarization follows a Maxwellian probability density function. The mean of the Maxwellian distributed instantaneous differential group delay is known as the average differential group delay, or the polarization mode dispersion value (PMD) of the fiber. The polarization mode dispersion value is, for long single-mode fibers with high polarization mode coupling, proportional to the square root of the fiber length.

To mitigate signal distortion due to polarization mode dispersion, optical elements introducing a similar amount of differential group delay as in the fiber but with an opposite sign, can be placed at the end of the fiber. Due to the random nature of the instantaneous differential group delay and the principal states of polarization in a long optical fiber, the optical elements used for compensating polarization mode dispersion must be adaptively adjusted to the momentary fiber conditions. A closed loop design, polarization mode dispersion compensator consequently consists of:

1. polarization transformer

2. PMD compensating optical elements (adaptive optics)

3. distortion analyzer

4. control logic as depicted in FIG. 1.

In FIG. 1, the distortion analyzer 14 provides a measure of signal distortion for the control logic 13 to adaptively adjust the polarization transformer 11 and the adaptive optics 12, such that they best match the momentary polarization mode dispersion conditions of the optical fiber.

Besides methods like, for example, spectral hole burning (SHB), direct eye-opening analyzing, etc., the degree of polarization (DOP) can be used for analyzing signal distortion due to polarization mode dispersion. For those who are skilled in the art, it is well known that a light beam experiences depolarization if the coherence length, which is inversely proportional to the spectral width, is in the order of the differential group delay. The higher the differential group delay becomes compared to the coherence length, the more the beam gets depolarized and its degree of polarization decreases. This well known physical effect is straightforward to be used as a feedback signal to adaptively control optical elements of a polarization mode dispersion compensator. Derivation of the depolarization of an optical signal due to fiber anisotropies as a function of signal spectrum (bandwidth, form), differential group delay and state of input polarization is shown in non-patent document 1.

Compared to spectral hole burning, measuring directly the eye-opening or bit-error rate detection, the advantages of using the degree of polarization as a feedback signal for adaptive polarization mode dispersion compensation are:

1. independent of bit rate

2. applicable to any modulation format without requiring modifications

3. insensitive to chromatic dispersion, such that degree of polarization provides a good measure of signal distortion due to only polarization mode dispersion

Depicted in FIG. 2 are, as a function of instantaneous differential group delay, the degree of polarization and Q-penalty of a transmitted signal, non-return to zero (NRZ) format modulated with a bit rate of 48 Gbit/s. The Q-penalty is defined here as:

$$Q \text{-} penalty = 20 \cdot log \frac{Eye \text{-} opening of received signal}{Back \text{-} to \text{-} back eye \text{-} opening} . \qquad ( 1 )$$

For reference, also shown in FIG. 2 is the power of the 24 GHz (half the bit rate) spectral component as a function of instantaneous differential group delay. The spectral component at half the bit rate has been proved to show the strongest dependence on instantaneous differential group.

Contrary to the degree of polarization which shows only one maximum if the instantaneous differential group delay vanishes, the 24 GHz spectral component shows a periodic behaviour. Therefore, in cases where the instantaneous differential group delay is expected to exceed on bit duration, at least one more spectral component, namely the 12 GHz (quarter of the bit rate) must be additionally tested to avoid an ambiguity.

The details of the degree of polarization and the power of spectral components at 24 GHz (half the bit rate), 12 GHz (quarter of the bit rate) and 6 GHz (eighth the bit rate) are depicted in FIG. 3 for small values of the instantaneous differential group delay.

FIG. 4 shows one configuration of a polarization transformer to realize general polarization transformation from one arbitrary varying input polarization to any varying output polarization. This configuration consists of 4 variable retarders 41, 42, 43, and 44 with fixed eigenaxis oriented at 0°, 45°, 0°, and 45°, respectively. Input light 45 passes through these retarders to be output as output light 46.

Provided that each of the retarders has an adjustment range of 4π, polarization transformation from one arbitrary varying input polarization to any varying output polarization is possible. But, if one of the retarders reaches an adjustment limit, i.e. the desired transformation requires adjustment in excess of the provided range, rewind operation is necessary. During the rewind operation, the retarder that reached its limit needs to be continuously brought back to a state which is far from the adjustment limit while the remaining three retarders have to take over polarization control. This kind of operation takes processing time which slows down the response speed to polarization fluctuations.

If a rewind operation needs to be performed in a situation where fast fluctuations appear to happen, polarization control may become impossible due to limited processing speed. For this reason, it is desirable to realize a polarization transforming apparatus which does in principal not require rewind operations.

To realize a general polarization transformation from one arbitrary varying input polarization to any varying output polarization without requiring rewind operations, several configurations exist (see non-patent document 2, for example).

FIG. 5 shows one configuration to realize such a general polarization transformation. This configuration consists of freely rotatable λ/4-, λ/2-, and λ/4-waveplates 51, 52, and 53 and is known to provide endless polarization transformations for one, and only one specific wavelength at which the waveplates introduce phase shifts of π/2, π, and π/2. Input light 54 passes through these waveplates to be output as output light 55.

The stringent requirement of exact phase shifts limits the usability of this configuration to only a very small wavelength range. Further limitations arise from the required mechanics, making this configuration very slow.

The basic structure for realizing a polarization transforming device on a lithium niobate (LiNbO₃) substrate is depicted in FIG. 6. It consists of a LiNbO₃ substrate 65, waveguide 64, buffer layer 66, and three electrodes 61, 62, and 63. The optical signal passes through the waveguide.

Grounding the center electrode 62 and applying positive or negative voltages to the outer electrodes 61 and 63 introduces a horizontal electrical field in the waveguide (x-direction). Applying voltages with reverse sign to the outer electrodes 61 and 63 introduces a vertical electrical field in the waveguide (y-direction). In a x-cut, z-propagating LiNbO₃ substrate, these electrical fields change the refractive indices over the electro-optic coefficient r₁₂.

Defining three voltages which describe the device characteristics

V_{bias} is the voltage for which intrinsic birefringence is canceled

V₀ is the voltage for which full transverse electric-transverse magnetic (TE-TM) mode conversion takes place

V_{π} is the voltage for which a phase shift of 180 degrees between the TE- and TM-mode is introduced,
the device can be controlled to behave like an endless rotatable 1/n-waveplate with a rotation angel θ/2. To achieve this, the voltage V₁ applied to the electrode 61 and the voltage V₃ applied to the electrode 63 calculate as:

$$\begin{matrix}{V}_{1} = \frac{{V}_{0}}{n / 2} sin ( θ ) - \frac{{V}_{π}}{n} cos ( θ ) - \frac{{V}_{bias}}{2} & ( 2 ) \\ {V}_{3} = \frac{{V}_{0}}{n / 2} sin ( θ ) + \frac{{V}_{π}}{n} cos ( θ ) + \frac{{V}_{bias}}{2} & ( 3 )\end{matrix}$$

This guarantees, in theory, operation like an endless rotatable waveplate. Because of applying the voltages in aperiodic fashion, control limits are never reached. Therefore, rewind operations are never required. What is required to guarantee the operation as an endless rotatable waveplate, is the knowledge of the device characteristics in terms of the voltages V_{bias}, V₀, and V_{π}.

Although these voltages can be acquired by measurement, they are subject to changes. In practice, these voltages not only depend on temperature and wavelength. Due to a drift caused by applying a direct-current (DC) voltage to such devices, the device characteristics change. In particular, the voltage Vbias is subject to change due to DC drift. Over time, device characteristics described in terms of the voltages V_{bias}, V₀, and V_{π} change. The initial set of voltages derived from a measurement become therefore invalid and operation of the device like an endless rotatable waveplate is no longer possible.

If a method is found which can derive the characteristics of the device during normal operation, the basic structure shown in FIG. 6 can be used to realize a polarization transformer with the principal capability of transforming any varying input polarization to any varying output polarization. Such a device is shown in FIG. 7. It consists of a LiNbO₃ substrate 81, waveguide 80, and three electrode sections. The first, second, and third section includes electrodes 71 through 73, 74 through 76, and 77 through 79, respectively. Grounding all center electrodes 72, 75, and 78 and applying voltages V₁, V₂, V₃, V₄, V₅, and V₆ to the outer electrodes 71, 73, 74, 76, 77, and 79, respectively in the form of

$$\begin{matrix}{V}_{1} = \frac{{V}_{0}}{2} sin ( α ) - \frac{{V}_{π}}{4} cos ( α ) - \frac{{V}_{bias}}{2} & ( 4 ) \\ {V}_{2} = \frac{{V}_{0}}{2} sin ( α ) + \frac{{V}_{π}}{4} cos ( α ) + \frac{{V}_{bias}}{2} & ( 5 ) \\ {V}_{3} = {V}_{0} sin ( β ) - \frac{{V}_{π}}{2} cos ( β ) - \frac{{V}_{bias}}{2} & ( 6 ) \\ {V}_{4} = {V}_{0} sin ( β ) + \frac{{V}_{π}}{2} cos ( β ) + \frac{{V}_{bias}}{2} & ( 7 ) \\ {V}_{5} = \frac{{V}_{0}}{2} sin ( γ ) - \frac{{V}_{π}}{4} cos ( γ ) - \frac{{V}_{bias}}{2} & ( 8 ) \\ {V}_{6} = \frac{{V}_{0}}{2} sin ( γ ) + \frac{{V}_{π}}{4} cos ( γ ) + \frac{{V}_{bias}}{2} , & ( 9 )\end{matrix}$$

the whole structure is operated like freely rotatable λ/4-, λ/2-, and λ/4-waveplates oriented at the angles α, β, and γ, respectively. The characteristic voltages V_{bias}, V₀, and V_{π} may differ for each of the three sections.

In the following, problems of the conventional polarization control are summarized.

The emphasis is on the application of polarization control for adaptive compensation of polarization mode dispersion (PMD) in high-speed optical telecommunication systems. PMD is well known to cause a spread of optical pulses during transmission. The two polarization modes in an optical fiber experience a differential group delay manifesting in pulse spreading. In order to compensate for PMD, a polarization controller (polarization transformer) followed by a differential group delay (DGD) element can be used. In this case, birefringent crystals like yttrium orthovanadate (YVO₄), titanium dioxide (TiO₂), calcium carbonate (CaCO₃), etc., or polarization maintaining fiber (PMF) are used as a DGD element. To compensate for PMD, the polarization controller has to be adjusted such that it transforms the fast eigenaxis of the DGD element to match the slow output principal state of polarization (PSP) of the transmission system. In this case, the DGD of the transmission fiber is reduced by the amount of DGD introduced by the DGD element following the polarization controller. In a second method, the polarization controller has to be adjusted such that the input PSP of the transmission fiber matches the state of polarization of the launched optical signal by transforming the eigenaxis of the DGD element in an appropriate way. Whatever method is used, required is the capability of endless transformation of the linear eigenaxis of the DGD element in order to follow arbitrary changes of the transmission fiber's PSP due to environmental influences.

As described above, two types of methods can be distinguished inprincipal for endless, reset-free polarization control:

1. those requiring rewind operations

2. those not requiring rewind operations

A device which requires rewind operations consists, for example, of four retarders oriented at 0°, 45°, 0°, and 45° with a retardation adjustment range of 4π. In this case, a fiber-squeezer, lead lanthanum zirconate titanate (PLZT), a liquid crystal (LC), or a Faraday rotator is used as a retarder. If, during operation, one of the retarders reaches a control limit, it must be rewound. This rewind operation is always possible for the above described device in the case the required operation is to transform any varying state of polarization to a static polarization, or vice versa. But, rewinding takes processing time and may fail if fast fluctuations occur or the application requires transformation of any varying polarization to any varying polarization.

A device which does not require rewind operations consists for example of a combination of endless rotatable quarter-, half-, and quarter-waveplate. To assure proper operation, the retardation of the waveplates is required to be exact. As a consequence, this device is only applicable for a very limited wavelength range. Furthermore, required mechanics make it a slow solution. Faster solutions are devices which either consist of five variable retarders oriented at 0°, 45°, 0°, 45°, and 0° (LC, PLZT, etc.) or 3-electrode structure LiNbO₃ based devices. Such devices provide in principal endless, reset-free operation if, and only if, the device properties (change of device characteristics with applied control signals) are well known. Calibration is possible, but only applicable in a stable environment and for a short time (temperature dependence, DC drift, ageing, etc.). These types of problems have also been discussed in other patent documents (see patent documents 1, 2, and 3, for example).

Because polarization controllers that do not require rewind operations do provide in principal the fastest and most reliable way of polarization control, devices constructed and controlled in a way that they always reliably provide desired transformation capability are particularly interesting. Applications of the devices include fast polarization control (stabilization) and fast PMD compensation.

Non-Patent Document 1

Jun-ichi Sakai, Susumu Machida, Tatsuya Kimura, “Degree of Polarization in Anisotropic Single-Mode Optical Fibers: Theory”, IEEE Journal of Quantum Electronics, Vol. QE-18, No. 4, pp. 488-495, 1982

Non-Patent Document 2

N. G. Walker and G. R. Walker, “Polarization control for coherent communications”, Journal of Lightwave Technology, Vol. 8, No. 3, pp. 438-458, 1990

Patent Document 1

published Japanese translation of PCT international publication for patent application (WO00/36459), No. 2002-532752

Patent Document 2

publication of Japan patent application, No. 2001-244896

Patent Document 3

publication of Japan patent application, No. 2002-033701

### DISCLOSURE OF INVENTION

It is an object of the present invention to provide a polarization control method to overcome the problem of changing device characteristics with environmental changes and time, and a polarization mode dispersion compensator which implements such a method.

In the first aspect of the present invention, the polarization mode dispersion compensator comprises a polarization transformer, a compensating optical unit, a distortion analyzer, and a control circuit. The polarization transformer transforms polarization of an input optical signal and the compensating optical unit compensates for a polarization mode dispersion of the input optical signal and outputs an output optical signal. The distortion analyzer measures a state of polarization and a distortion of the output optical signal and generates a feedback signal indicating the measured state of polarization and distortion. The control circuit generates, based on the feedback signal, control signals for adjusting the polarization transformer in such a way that a plurality of target states of polarization in which the distortion is measured are realized in output optical signals in following operations.

In the second aspect of the present invention, the distortion analyzer measures a degree of polarization of the output optical signal as distortion information. Then, the control circuit generates the control signals for adjusting the polarization transformer in such a way that an optimum state is found from among the target states of polarization by searching for a state with the maximum degree of polarization in a circumference of an actual state in a polarization space.

In the third aspect of the present invention, the distortion analyzer measures a degree of polarization of the output optical signal as distortion information. Then, the control circuit records the measured state of polarization and degree of polarization, and calculates from polarization changes control signals for adjusting the polarization transformer in such a way that the target states of polarization are equally separated from each other and equally distant from the actual state in the polarization space. In this case, the target states of polarization may be preset and located on a circle around the actual state at a predefined distance in the polarization space.

In the fourth aspect of the present invention, the distortion analyzer measures a degree of polarization of the output optical signal as distortion information. Then, the control circuit records the measured state of polarization and degree of polarization, calculates from polarization changes control signals for adjusting the polarization transformer in such a way that the target states of polarization are unequally separated from each other and unequally distant from the actual state in the polarization space, and weights measured degrees of polarization in the target states of polarization by using a distance between each target state of polarization and the actual state in the polarization space.

In the fifth aspect of the present invention, the control circuit recognizes changing device characteristics of the polarization transformer in a case where a part of the target states of polarization are not be realized, and takes countermeasures such that the polarization transformer operates like endless rotatable waveplates by recalculating a voltage which describes the device characteristics of the polarization transformer and generating a control signal for applying the calculated voltage to the polarization transformer.

### BRIEF DESCRIPTION OF DRAWINGS

FIG. 1 shows a configuration of a conventional polarization mode dispersion compensator.

FIG. 2 shows degree of polarization, Q-penalty and a spectral component as a function of instantaneous differential group delay.

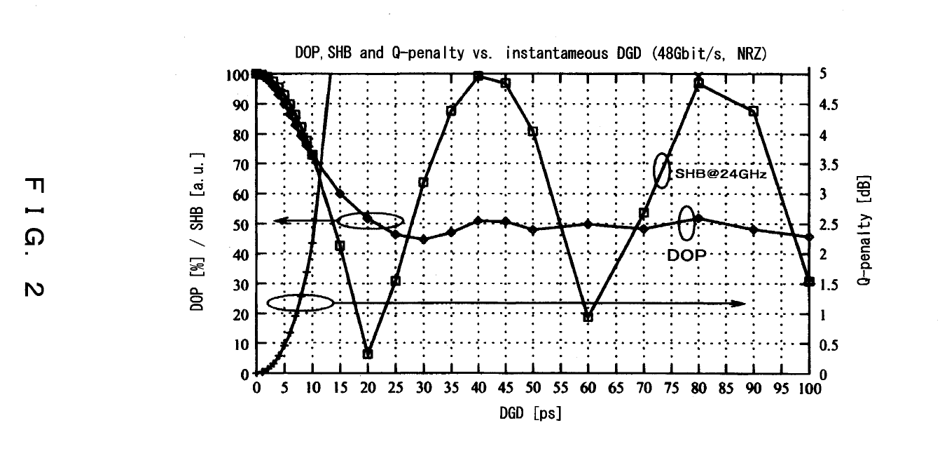

FIG. 3 shows detail of degree of polarization, Q-penalty and a spectral component as a function of instantaneous differential group delay.

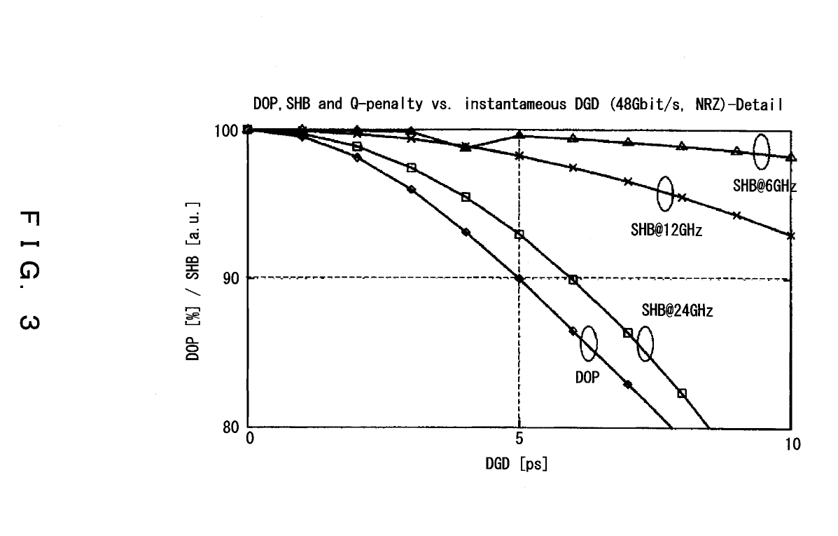

FIG. 4 shows a configuration of a polarization transformer which consists of 4 variable retarders.

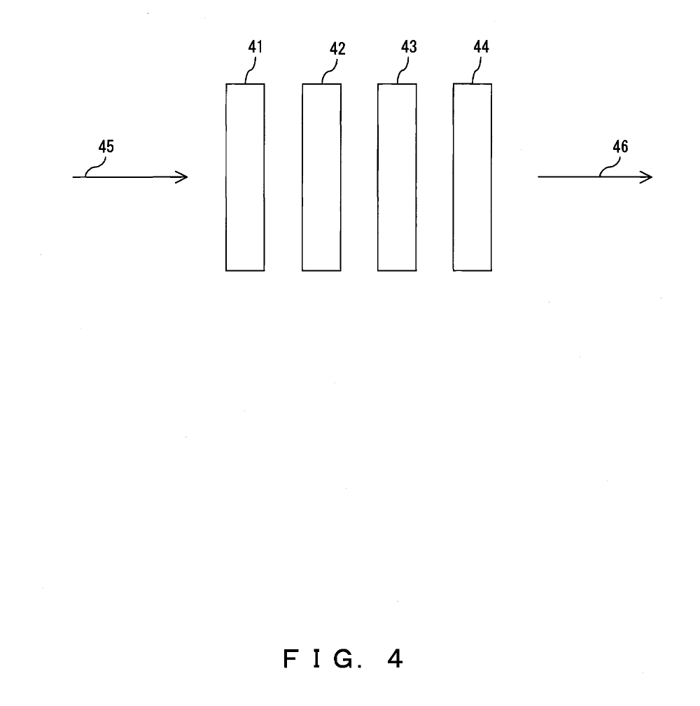

FIG. 5 shows a configuration of a polarization transformer which consists of 3 rotatable waveplates.

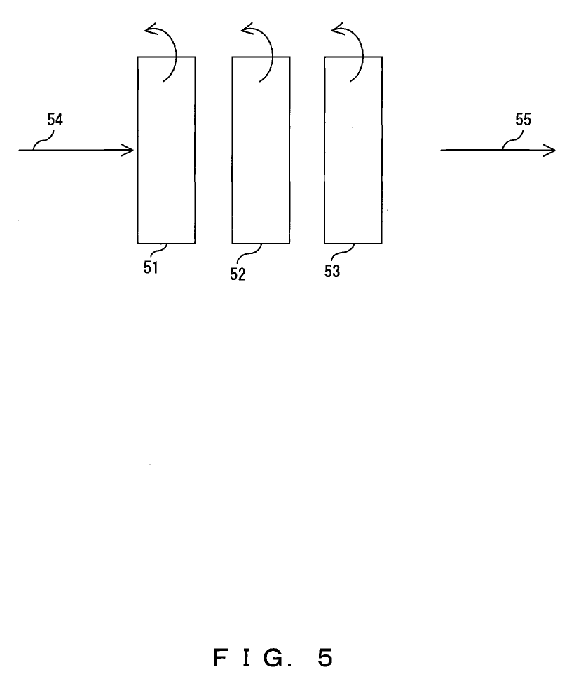

FIG. 6 shows a basic structure of a polarization transformer on a LiNbO₃ substrate.

FIG. 7 shows a basic structure of a polarization transformer on a LiNbO₃ substrate with the capability of transforming any varying input polarization to any varying output polarization.

FIG. 8 shows a configuration of a polarization mode dispersion compensator which employs a degree of polarization as information of a signal distortion.

FIG. 9 shows a flowchart of an operation of a polarization mode dispersion compensator.

FIG. 10 shows search for an optimum state on a Poincaré-sphere.

FIG. 11 shows search for an optimum state in a 2-dimensional polarization space.

FIG. 12 shows another search for an optimum state on a Poincaré-sphere.

FIG. 13 shows another search for an optimum state in a 2-dimensional polarization space.

FIG. 14 shows a situation in which desired polarizations are not able to be reached.

FIG. 15 shows a concrete example of a configuration of a polarization mode dispersion compensator.

FIG. 16 shows a configuration of a polarization mode dispersion compensator which employs a photodiode and a band-pass filter to detect a signal distortion.

FIG. 17 shows a configuration of a polarization mode dispersion compensator which employs a forward error correction unit to detect a signal distortion.

### BEST MODE FOR CARRYING OUT THE INVENTION

Hereinafter, preferred embodiments according to the present invention will be described in detail by referring to the drawings.

To overcome the problem of changing device characteristics with environmental changes and time, a method using the information provided by a polarimeter, which is used anyway in an advantageous realization of a PMD compensator for feedback, is employed. Integration of the method into the timing of the control makes it possible to apply it without increasing processing time or demanding more sophisticated control logic.

Although a degree of polarization (DOP) as a measure of signal distortion due to polarization mode dispersion can be used to control a PMD compensator, it is advantageous to use additional information on the state of polarization—in particular the variation of the state of polarization with the changing control signals applied to the polarization transformer—to compensate for changing characteristics of the polarization transformer. In the following, various methods will be described for applying the DOP as a feedback signal to adaptive polarization mode dispersion compensators (PMDCs) and using the additional information on the state of polarization for advantageous realization of the control algorithm that is tolerant to changing device characteristics.

Assuming the PMDC is initially in an optimum state, i.e. it compensates for distortion due to PMD to the best of the ability of the compensating optics, this optimum state corresponds to a maximized DOP. Additionally, the state of polarization as measured by the polarimeter is known. This state of polarization is fully described by two variables (angles): the azimuth θ and the ellipticity ε. If the PMD condition of the transmission span in front of the PMDC changes, both the DOP and the state of polarization will change. The PMDC is then no longer in an optimum state. In order to find the new optimum state, i.e. control signals applied to the polarization transformer and the compensating optics, the PMDC has to test the DOP in the circumference of the old optimum state. This can be done by applying slightly changed control signals while searching for those changes that lead to an increase of the DOP. Two problems arise using this simple approach in practical systems:
1. Due to changing characteristics of the polarization transforming device, it cannot be guaranteed that the required transformation for adjusting the PMDC to its optimum state is possible. Worse still, by only using the DOP as a measure of signal distortion and for providing feedback to the control logic, it is not even possible to identify those situations in which a required transformation cannot be performed. This problem is not limited to the use of DOP as the feedback signal for a PMD compensating device. It also applies to other feedback methods like spectral-hole burning, eye-opening measurement, orbit-error rate. All these methods only provide a measure of distortion.
2. Changing the control signals by predefined steps does by no means imply, that the PMDC changes its compensating state by distinct steps. In fact, depending on the PMD condition of the transmission span, and the state of the PMDC, a change of one control signal might lead to only a very small change of the compensating state of the PMDC. Even situations in which any change of one control signal does not lead to any change in the compensating state of the PMDC might appear. For example, such situations happen, if the polarization to be transformed comes close to an eigenaxis of one of the sections of the polarization transforming device.

To overcome the problems associated with 1 and 2, the polarization transforming device of a PMDC is controlled according to the following description. Initially, the PMDC is set to a condition at which it compensates for PMD to the best of the capability of the compensating optics by finding the maximum DOP. This is performed by adjusting the polarization transforming device such that the polarizations as measured by the polarimeter cover the whole Poincaré-sphere (−45°≦Ellipticity ε<45°, −90°≦Azimuth θ<90°) and calculating the DOP value. From the resulting 2-dimensional map of DOP values versus azimuth and ellipticity, the global maximum for the DOP is known. The polarization transformer of the PMDC is set to the condition corresponding to this maximum DOP value. In the case where the compensating optics provide additional adjustment capability, i.e. added degrees of freedom, the control parameters can be successively changed while taking the 2-dimensional DOP map to find the global optimum. The operation described above to find the global optimum is only allowed at times the PMDC is switched on. During the operation of a transmission system, the PMDC is not allowed to scan through all its possible states for finding the global maximum because this operation introduces high distortions to the optical signal. During the operation of a transmission system, the PMDC is required to track changing PMD conditions, and find its optimum state without introducing unacceptable signal distortions. Dithering the control signals (applying small changes to the control signals) would be one method to track the optimum state. Due to changing device characteristics (ageing, temperature, etc.) the problems described above will occur in practical applications. To overcome those problems, in an advantageous method optimization of the state of the polarization transforming device is not performed over the space of control signals, but over the space of polarizations as measured by the polarimeter.

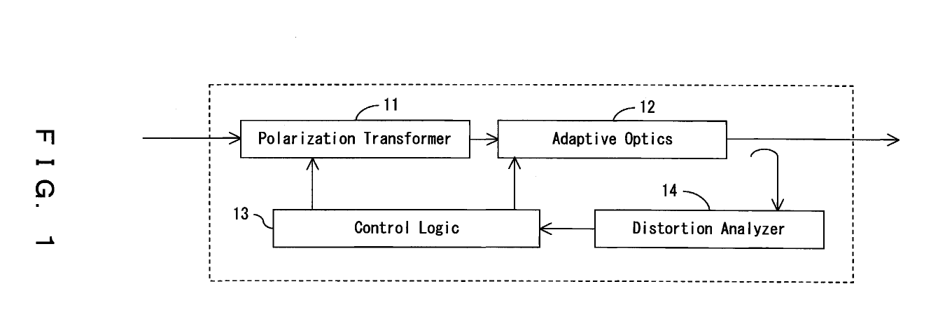

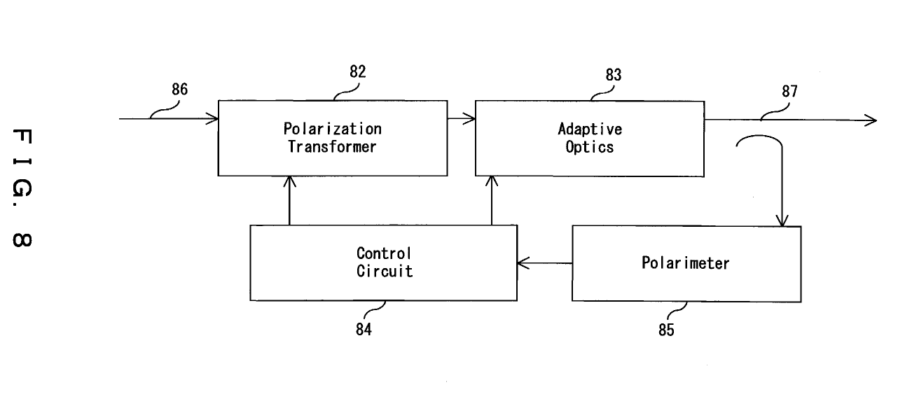

FIG. 8 shows a configuration of a PMDC employing the advantageous method. The PMDC comprises polarization transformer 82, adaptive optics 83, control circuit 84, and polarimeter 85. Input light 86 passes through the polarization transformer 82 and the adaptive optics 83 to be output as output light 87. The polarimeter 85 corresponds to the distortion analyzer 14 in FIG. 1 and measures the state and degree of polarization of the output light 87 to generate a feedback signal. The control circuit 84 generates control signals for the polarization transformer 82 and the adaptive optics 83 using the feedback signal from the polarimeter 85.

Describing the state of polarization in terms of the Stokes-vector \vec{S}

$${S}^{->} = ( \begin{matrix}{S}_{0} \\ {S}_{1} \\ {S}_{2} \\ {S}_{3}\end{matrix} ) , \qquad ( 10 )$$

the DOP is calculated as the quotient of the polarized light power and the total power:

$$DOP = \frac{\sqrt{{S}_{1}^{2} + {S}_{2}^{2} + {S}_{3}^{2}}}{{S}_{0}} . \qquad ( 11 )$$

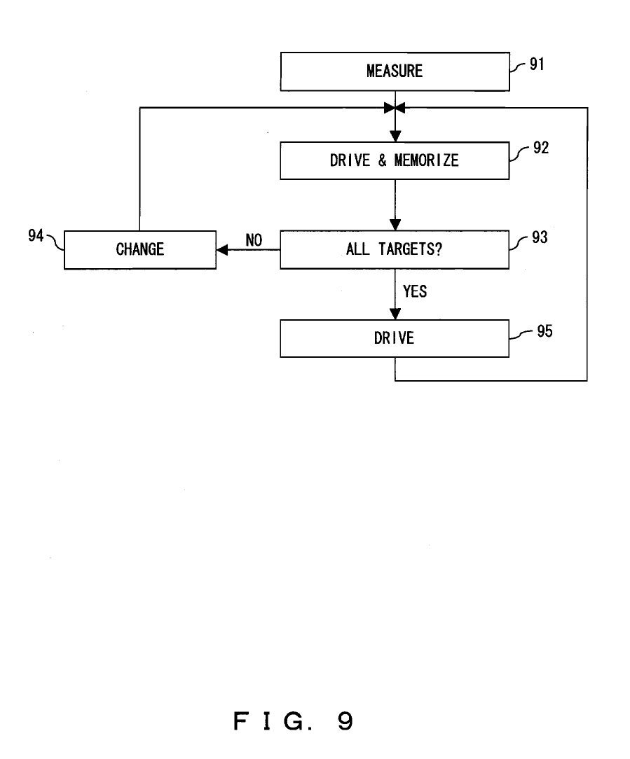

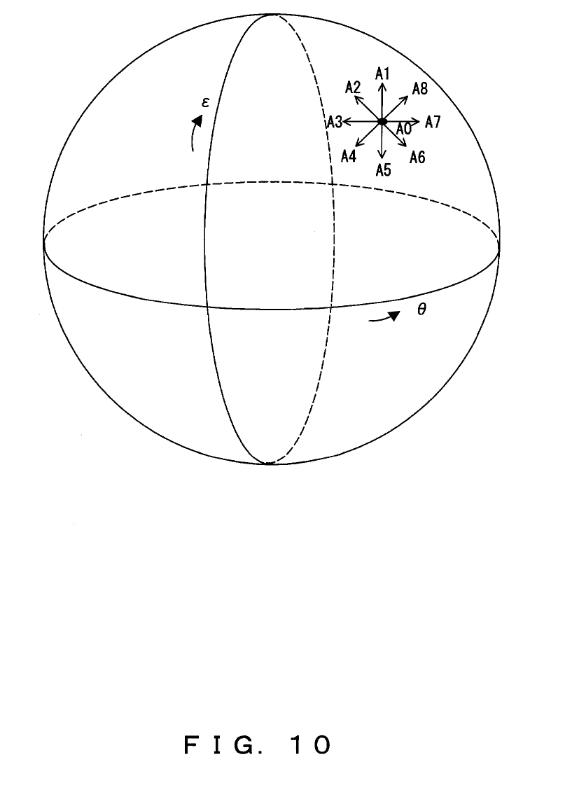

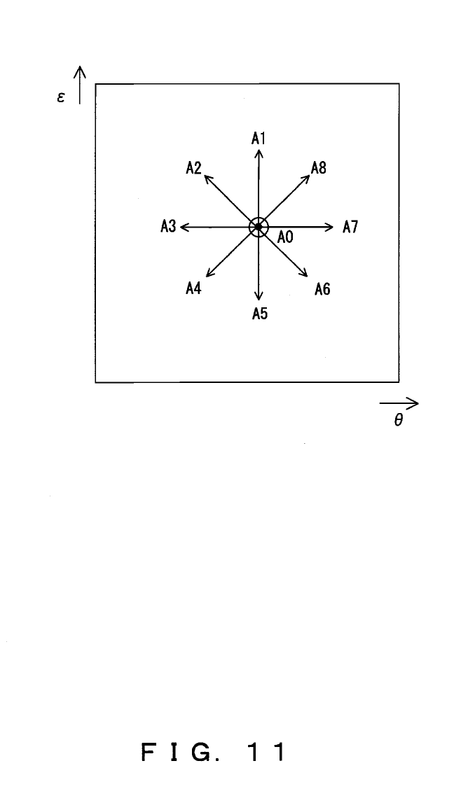

This PMDC operates according to the flowchart shown in FIG. 9. First, the polarimeter 85 measures the initial Stokes-vector and DOP at the initial optimum position in a polarization space (Step 91). An example of the initial optimum position A0 on the Poincaré-sphere is depicted in FIG. 10. FIG. 11 shows another view of A0 in a 2-dimensional space of angles θ and ε.

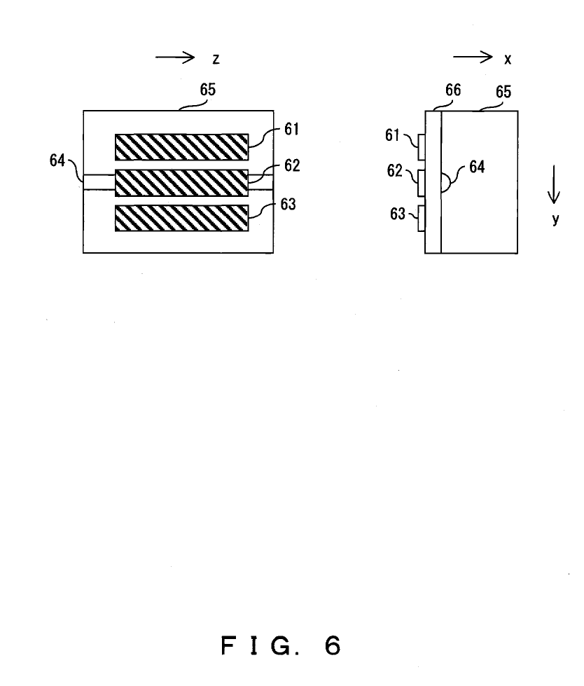

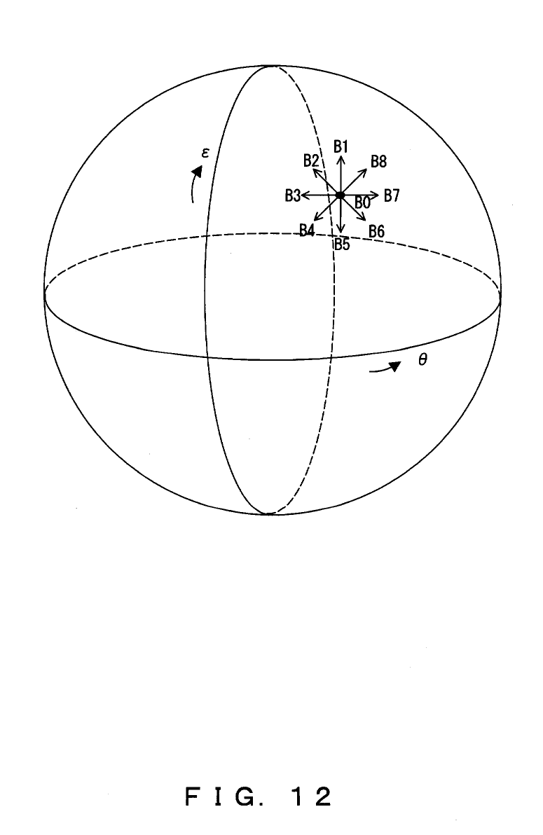

The control circuit 84 drives the polarization transformer 82 such that Stokes-vectors are on a circle around A0 and memorizes associated DOP values (Step 92). In FIGS. 10 and 11, 8 target positions A1 through A8 are located on the circle around A0 for example. Then, the control circuit 84 checks whether all the target positions could be realized (Step 93). If one of the target positions could not be realized, the control circuit 84 changes the device characteristics of the polarization transformer 82 (Step 94) and repeats the operations in and after Step 92. In the case where a polarization transforming device on a LiNbO₃ substrate as shown in FIG. 6 is used, control signals to change V_{bias}, V₀, and V_{π} are output to the polarization transformer 82. If all the target positions could be realized, the control circuit 84 drives the polarization transformer 82 such that Stokes-vector is the one with the maximum associated DOP among the Stokes-vectors for the target positions (Step 95) and repeats the operations in and after Step 92 with the position of the maximum DOP as a new initial position. In the case where A4 among A1 through A8 is associated with the maximum DOP, this position becomes the new initial position B0 as shown in FIG. 12 and new target positions B1 through B8 are to be realized.

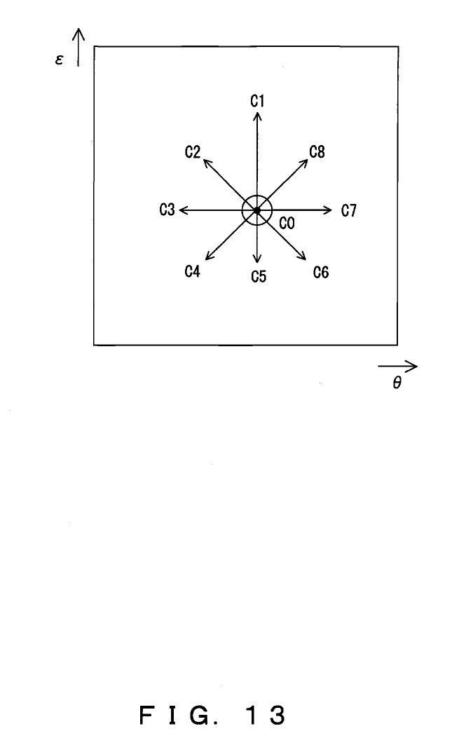

According to the above-described control, starting from the initial optimum state, the control signals applied to the polarization transformer 82 are adjusted such that the polarizations as measured by the polarimeter 85 are located on a circle around the intial optimum position A0. From the measured DOP values at each of the positions A1 through A8, the direction pointing to the new optimum state is calculated. If the PMD condition of the transmission system has not changed, all the DOP values at A1 through A8 are lower than the DOP value at the initial state. The polarization transformer 82 is then redirected to this initial state, from which it starts again to probe the DOP values in the circumference of the initial polarization. If the PMD condition has changed, at least one of the DOP values measured at A1 through A8 is higher than the initial DOP value. The polarization transformer 82 is then adjusted to this new state from which it starts again to probe the DOP values in the circumference of the new state. Repeating the above steps over and over again, the polarization transforming device of the PMDC tracks changing PMD conditions of the transmission system. In order to find the control signals leading to equally separated states in the polarization space at which the DOP value is probed, the control starts with an arbitrary initial set of control signals. Both the control signals and the changes in the state of polarization are recorded. With the knowledge of what control signals lead to what polarization changes, the next set of control signals can be calculated such that in the next sequence polarizations come closer to the ideal condition of equal separation. Repeating this operation over and over again, the set of control signals to be applied for equally separated polarization at which the DOP value is measured is found. For example, a sub-optimal set of probed polarization states is shown in FIG. 13. Here, C1 through C8 around the initial position C0 are realized and only the polarization at C1 appears to be in an ideal distance to the actual polarization. Subsequent states are at a reduced distance. The algorithm calculates from the known distances new sets of control signals, such that at next operations short distant polarizations are located farther away from the actual state.

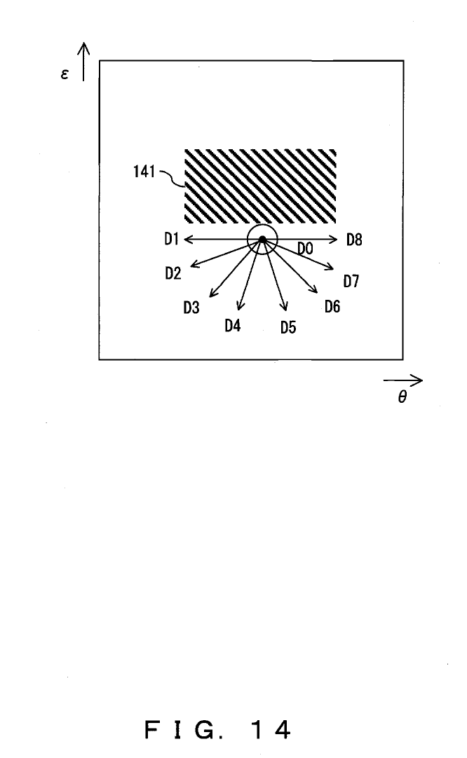

A situation which appears to happen if the device characteristics of the polarization transformer 82 have changed, is shown in FIG. 14. Although polarizations at the positions D1 through D8 are realized in the circumference of the actual state at the position D0, the control algorithm is by no means able to reach the desired polarizations 141 by controlling the polarization transformer 82 in a way such that it operates like endless rotatable waveplates using the device describing voltages. Experiencing such a situation, the control algorithm slightly varies the voltages describing the device characteristics of the polarization transformer 82 such that all the target polarizations are located again on a circle around the initial polarization. Because the target polarizations are given (they have to be located on a circle around the initial state), situations at which the device characteristics of the polarization transformer 82 are changed can always be recognized.

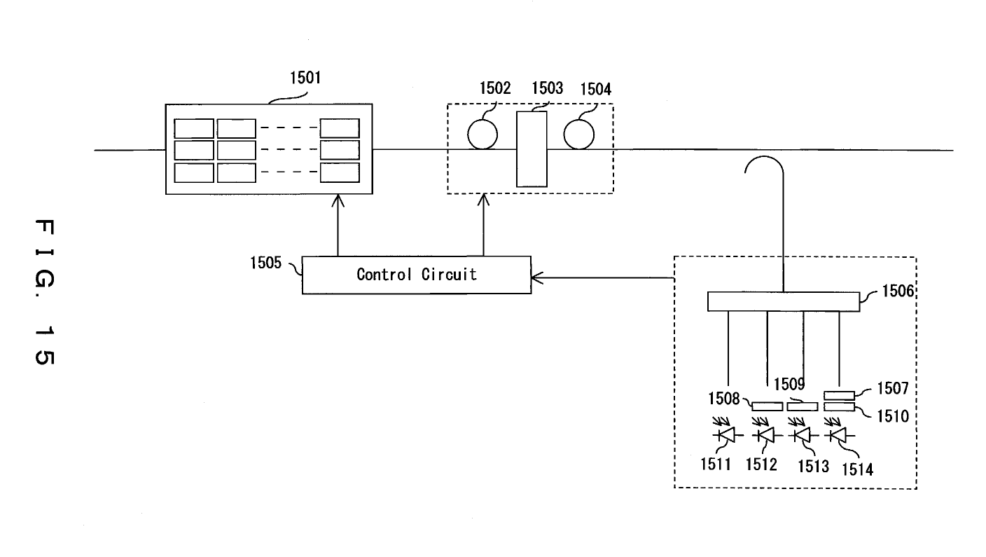

FIG. 15 shows a concrete example of the configuration of the PMDC shown in FIG. 8. The PMDC comprises polarization transforming device 1501, polarization maintaining fibers 1502 (0°) and 1504 (90°), control circuit 1505, variable retarder 1503 (45°), beam splitter 1506, retarder 1507 (π/4), polarizers 1508 (0°), 1509 (45°), and 1510 (0°), and photodiodes 1511 through 1514. The polarization transforming device 1501 and the control circuit 1505 correspond to the polarization transformer 82 and the control circuit 84 in FIG. 8, respectively. The polarization maintaining fibers 1502 and 1504 and variable retarder 1503 corresponds to the adaptive optics 83 in FIG. 8. The beam splitter 1506, retarder 1507, polarizers 1508 through 1510, and photodiodes 1511 through 1514 form the polarimeter 85 in FIG. 8.

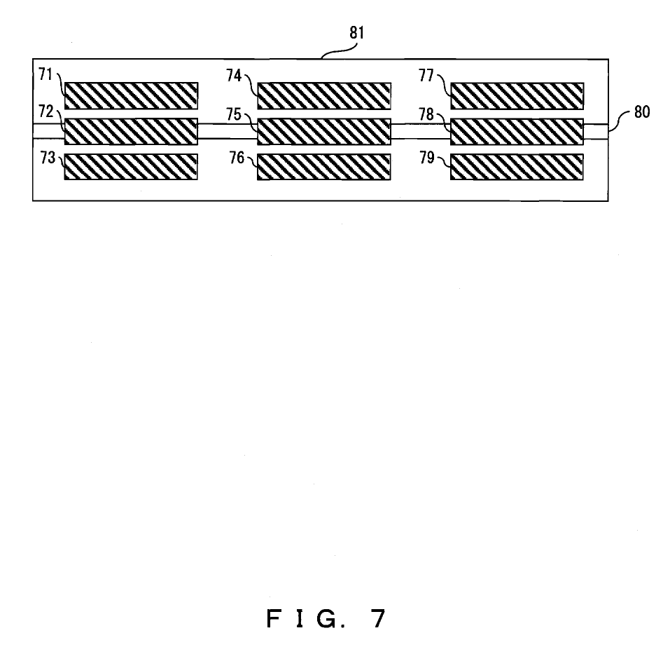

The polarization transforming device 1501 is realized by at least three or multiple three-electrode structures on a LiNbO₃ substrate as shown in FIG. 7. The adaptive optics comprise two sections of differential group delay introducing elements 1502 and 1504 separated by a variable retarder 1503 and the eigenaxis of the variable retarder 1503 is oriented at 45° with respect to the eigenaxis of each differential group delay introducing elements. More generally, the adaptive optics may comprise multiple sections of differential group delay introducing elements separated by individually controllable variable retarders with the eigenaxis oriented at 45° with respect to the eigenaxis of each of two adjacent differential group delay introducing elements. Denoting the intensities detected by the photodiodes 1511, 1512, 1513, and 1514 as I₀, I₁, I₂, and I₃, respectively, the Stokes-vector \vec{S} can be obtained by the following equations.

$$\begin{matrix}{I}^{->} = ( \begin{matrix}{I}_{0} \\ {I}_{1} \\ {I}_{2} \\ {I}_{3}\end{matrix} ) & ( 12 ) \\ {S}^{->} = E \cdot {I}^{->} \\ E \text{:} unit matrix & ( 13 )\end{matrix}$$

Target positions are located on a circle in the above-described embodiments, however, the proposed method is not limited to Stokes-vectors targeted to surround the initial position on a circle. A circle is the most straightforward shape to implement and does not require weighting. Shapes other than a circle require weighting for the decision of the next initial position. An ellipse, for example, can be used as a shape on which target positions are located. Weighting can be performed by (but is not limited to) multiplying measured DOP values at positions A1 through A8 by the inverse distance from the initial position A0. This is an effective countermeasure against otherwise possible misjudgements due to underestimating the significance of small DOP changes for small distances.

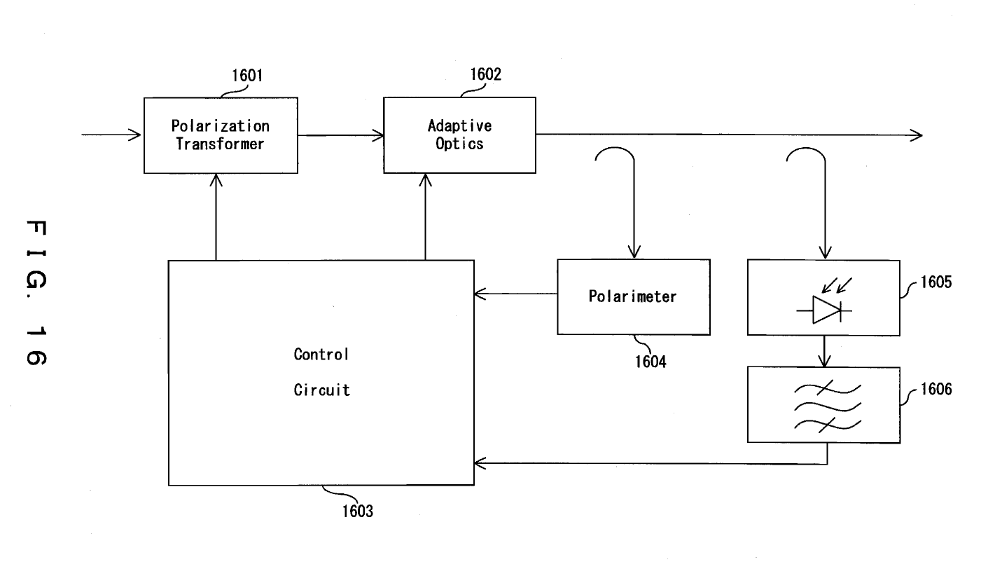

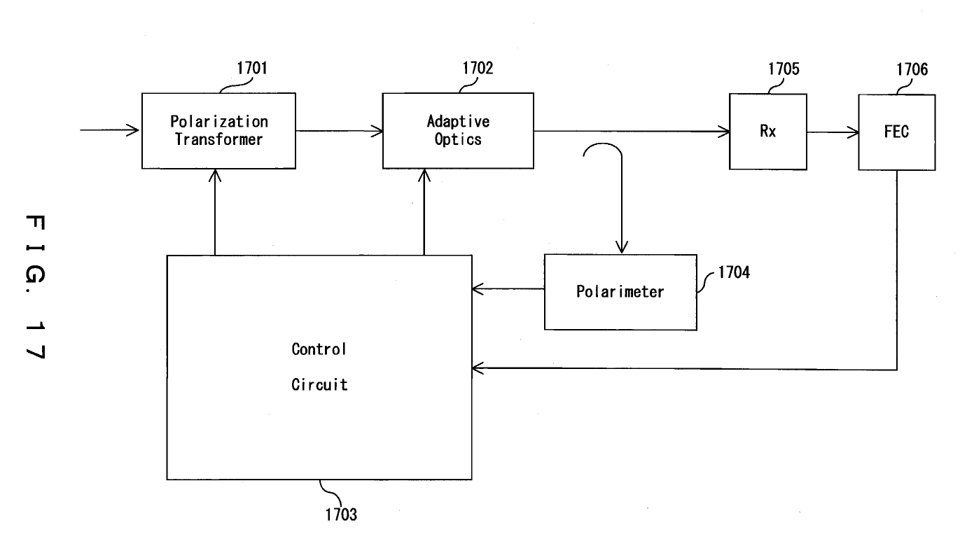

Furthermore, it is possible to use other information indicating the signal distortion as a feedback signal. Examples are shown in FIGS. 16 and 17.

The PMDC shown in FIG. 16 comprises polarization transformer 1601, adaptive optics 1602, control circuit 1603, polarimeter 1604, a photodiode 1605, and a band-pass filter 1606. The polarimeter 1604 measures the state of polarization (Stokes-vector) of the output light to generate a feedback signal. This is required to track whether target SOPs on a circle around the initial position could be realized. The photodiode 1605 detects the output light to generate an electric signal and the band-pass filter 1606 generates a feedback signal for the decision of a next initial position. The band of the band-pass filter 1606 is determined such that a specific frequency component of B/n (B: the bit-rate of the signal light, n=2, 4, 6, . . . ) can be detected. The control circuit 1603 generates control signals for the polarization transformer 1601 and the adaptive optics 1602 using the feedback signals from the polarimeter 1604 and the band-pass filter 1606.

The PMDC shown in FIG. 17 comprises polarization transformer 1701, adaptive optics 1702, control circuit 1703, and polarimeter 1704. Receiver unit 1705 and forward error correction (FEC) unit 1706 are provided in the receiver side. The polarimeter 1704 measures the state of polarization (Stokes-vector) of the output light to generate a feedback signal as in the configuration shown in FIG. 16. The forward error correction unit 1706 generates a feedback signal of an error count as information for the decision of a next initial position. The control circuit 1703 generates control signals for the polarization transformer 1701 and the adaptive optics 1702 using the feedback signals from the polarimeter 1704 and the forward error correction unit 1706.

As described in detail above, according to the present invention, a polarization control that is tolerant to changing device characteristics of a PMDC with environmental changes and time is provided. Therefore, it is possible to adjust the PMDC to its optimum state even in the case where the device characteristics change.

1. A polarization mode dispersion compensator comprising:
a polarization transformer to transform polarization of an input optical signal;
a compensating optical unit to compensate for a polarization mode dispersion of the input optical signal and output an output optical signal;
a polarimeter to measure a state of polarization and a degree of polarization of the output optical signal and generate a feedback signal indicating the measured state of polarization and degree of polarization; and
a control circuit to generate, based on the feedback signal, control signals for adjusting the polarization transformer in such a way that a plurality of target states of polarization in which the degree of polarization is measured are realized in output optical signals in following operations.

2. The polarization mode dispersion compensator according to claim 1, wherein
the polarization transformer is realized by multiple three-electrode structures on a LiNbO₃ substrate, whereby control voltages are applied such that a device operation of the polarization transformer corresponds to endless rotatable waveplates.

3. The polarization mode dispersion compensator according to claim 1, wherein
the compensating optical unit is realized in such a way that an amount of differential group delay is introduced by one of a polarization maintaining fiber and a birefringent crystal.

4. The polarization mode dispersion compensator according to claim 1, wherein
the compensating optical unit comprises a plurality of sections of differential group delay introducing elements separated by at least one individually controllable variable retarder with an eigenaxis oriented at an angle of 45 degree with respect to an eigenaxis of each of two adjacent differential group delay introducing elements.

5. The polarization mode dispersion compensator according to claim 1, wherein
the control circuit generates the control signals for adjusting the polarization transformer in such a way that an optimum state is found from among the target states of polarization by searching for a state with the maximum degree of polarization in a circumference of an actual state in a polarization space.

6. The polarization mode dispersion compensator according to claim 5, wherein
the control circuit records the measured state of polarization and degree of polarization, and calculates from polarization changes control signals for adjusting the polarization transformer in such a way that the target states of polarization are equally separated from each other and equally distant from the actual state in the polarization space.

7. The polarization mode dispersion compensator according to claim 6, wherein
the target states of polarization are preset and located on a circle around the actual state at a predefined distance in the polarization space.

8. The polarization mode dispersion compensator according to claim 5, wherein
the control circuit records the measured state of polarization and degree of polarization, calculates from polarization changes control signals for adjusting the polarization transformer in such a way that the target states of polarization are unequally separated from each other and unequally distant from the actual state in the polarization space, and weights measured degrees of polarization in the target states of polarization by using a distance between each target state of polarization and the actual state in the polarization space.

9. The polarization mode dispersion compensator according to claim 1, wherein
the control circuit recognizes changing device characteristics of the polarization transformer in a case where a part of the target states of polarization are not realized, and takes countermeasures such that the polarization transformer operates like endless rotatable waveplates by recalculating a voltage which describes the device characteristics of the polarization transformer and generating a control signal for applying the calculated voltage to the polarization transformer.

10. A polarization mode dispersion compensator comprising:
a polarization transformer to transform polarization of an input optical signal;
a compensating optical unit to compensate for a polarization mode dispersion of the input optical signal and output an output optical signal;
a distortion analyzer to measure a state of polarization and a distortion of the output optical signal and generate a feedback signal indicating the measured state of polarization and distortion; and
a control circuit to generate, based on the feedback signal, control signals for adjusting the polarization transformer in such a way that a plurality of target states of polarization in which the distortion is measured are realized in output optical signals in following operations.

11. A method of polarization mode dispersion compensation, comprising:
transforming polarization of an input optical signal through a polarization transformer;
compensating for a polarization mode dispersion of the input optical signal through a compensating optical unit to generate an output optical signal;
measuring a state of polarization and a distortion of the output optical signal to generate a feedback signal indicating the measured state of polarization and distortion; and
adjusting the polarization transformer according to the feedback signal in such a way that a plurality of target states of polarization in which the distortion is measured are realized in output optical signals in following operations.
